(19) United States
(12) Patent Application Publication
(10) Pub. No.: US 2011/0197200 A1
(43) Pub. Date: Aug. 11, 2011

(54) DECODING LOCATION INFORMATION IN CONTENT FOR USE BY A NATIVE MAPPING APPLICATION

(75) Inventors: Haitao Huang, Chandler, AZ (US); Franck R. Kirouchenaradje, Phoenix, AZ (US); Daniel K. Palmer, Phoenix, AZ (US); Juan C. Uribe, Chandler, AZ (US); Chetan V. Kale, Chandler, AZ (US)

(73) Assignee: GARMIN LTD., Camana Bay (KY)

(21) Appl. No.: 12/724,210

(22) Filed: Mar. 15, 2010

Related U.S. Application Data
(60) Provisional application No. 61/303,436, filed on Feb. 11, 2010.

(51) Int. Cl. G06F 9/46

(52) U.S. Cl. 719/313; 719/328

(57) ABSTRACT

Techniques are described to decode location information in content accessed by a mobile electronic device and pass the decoded information to a native mapping application to provide an enhanced user experience. In an implementation, location information is decoded by parsing a map link in content accessed by the mobile electronic device or from location information parameters associated with a mapping application programming interface (API) call made by a mapping script embedded in the content. The decoded location information is passed to a native mapping application of the mobile electronic device. A map-related function may then be provided by the mobile electronic device by accessing functionality of the native mapping application using the decoded location information.

### RELATED APPLICATION

This application, under the provisions of 35 U.S.C. §119(e), claims the benefit of and priority to U.S. Provisional Application Ser. No. 61/303,436, filed Feb. 11, 2010, and entitled “DECODING LOCATION INFORMATION IN CONTENT FOR USE BY A NATIVE MAPPING APPLICATION”, the disclosure of which is incorporated herein by reference in its entirety.

### BACKGROUND

Because of their relatively small size and form, mobile electronic devices such as smart phones, mobile phones, personal navigation devices (PNDs), personal digital assistants (PDAs), and so forth, offer several practical advantages with respect to providing maps and map-related content to a user. For example, because of their small form and consequent portability, mobile electronic devices are capable of providing real-time navigational instructions to users in a convenient fashion, while the users are in route to a destination. However, the small form of these devices may also impose certain practical limitations with respect to interaction of the users with these devices. For example, mobile electronic devices are often used to access content formatted for display by monitor of a conventional personal computer or laptop. Consequently, when accessed using a mobile electronic device, such content may be difficult to comprehend or improperly formatted.

### SUMMARY

Techniques are described to improve the display of maps and map-related content by a mobile electronic device to provide an enhanced user experience. In an implementation, location information is decoded from a map link embedded in content accessed by mobile electronic device or from location information parameters associated with an application programming interface (API) call made by a mapping script embedded in the content. The decoded location information is passed to a native mapping application of the mobile electronic device. A map-related function may then be provided by the mobile electronic device by accessing functionality of the native mapping application using the decoded location information.

This Summary is provided solely to introduce subject matter that is fully described in the Detailed Description and Drawings. Accordingly, the Summary should not be considered to describe essential features nor be used to determine scope of the claims.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example environment in which techniques to decode location information in content accessed by a mobile electronic device and pass the decoded information to a native mapping application may be implemented.

FIG. 2 is an illustration of a display screen of the mobile electronic device of FIG. 1, wherein the display screen is configured to display content that contains a map link from which the location information may be obtained.

FIG. 3 is an illustration of a display screen of the mobile electronic device of FIG. 1, wherein the display screen is configured to display content provided by a web mapping service website.

FIG. 4 is an illustration of a display screen of the mobile electronic device of FIG. 1, wherein the display screen is configured to display content that contains an embedded map provided by a web mapping service.

FIG. 5 is a flow diagram depicting a procedure in an example implementation in which location information in content accessed by a mobile electronic device is decoded and passed to a native mapping application.

FIG. 6 is an illustration of a display screen of the mobile electronic device of FIG. 1, wherein an icon configured to access the native mapping application is injected into the content displayed in the display screen.

FIG. 7 is an illustration of a display screen of the mobile electronic device of FIG. 1 that includes a menu configured to access the native mapping application.

FIG. 8 is an illustration of a map display screen of the mobile electronic device of FIG. 1, wherein the map display screen is configured to display a map generated by the native mapping application.

FIG. 9 is an illustration of a display screen of the mobile electronic device of FIG. 1 that includes a menu configured to access the native mapping application.

FIG. 10 is an illustration of a display screen of the mobile electronic device of FIG. 1, wherein the display screen is configured to display content that includes an embedded map generated by the native mapping application.

FIG. 11 is an illustration of a display screen of the mobile electronic device of FIG. 1, wherein the display screen is configured to display a webpage from a website that employs predefined native mapping APIs to access the native mapping application to embed a map within a webpage.

### DETAILED DESCRIPTION

Overview

Web mapping services allow users to access maps and map-related content via the World Wide Web. Many web mapping services support the use of special hyperlinks that may be added to third-party content such as a webpage, a document, an email, a text message, and so on, to link to a mapping website furnished by the web mapping service. When selected, these hyperlinks (hereinafter referred to as “map links”) cause the mapping website to be accessed by the device's browser, for example, to display a map of a desired location or furnish driving directions. Some web mapping services further allow maps and/or map-related content from the mapping website to be embedded directly into third-party websites using pre-defined application programming interfaces (APIs).

Often, maps and map-related content furnished by web mapping services in this manner are formatted for display by the browser of a conventional personal computer or laptop. When accessed using a mobile electronic device, such content can be poorly formatted for the device's display, which may have a limited viewing area in comparison to a conventional computer or laptop. Consequently, the user may be forced to zoom or scroll the display to view desired information within the content. Moreover, maps generated by web mapping services typically comprise a large amount of data that must be loaded across a wireless mobile data network when accessed by a mobile electronic device. Thus, content provided by a mapping website is often slow to open within the browser, resulting in a poor user experience.

Accordingly, techniques are described that may be implemented in a mobile electronic device to utilize the functionality of the device's native mapping application to supplement or replace content furnished by a web mapping service. In this manner, the native mapping application may be used to enhance the content-viewing experience provided by the device. In an implementation, the techniques allow location information to be decoded from content accessed by the mobile electronic device. The location information may be decoded by parsing a map link in the content or from location information parameters associated with a mapping API call made by a mapping script (e.g., JavaScript) embedded in the content. The decoded location information is passed to the native mapping application, which provides mapping functionality configured for the mobile electronic device. Map-related functions may then be provided by the mobile electronic device by accessing functionality of the native mapping application using the decoded location information. The map-related functions may also enrich remote content accessed by the mobile electronic device using the native mapping application and/or other local data.

In the following discussion, an example mobile electronic device environment is first described. Exemplary procedures are then described that may be employed with the example environment, as well as with other environments and devices without departing from the spirit and scope thereof. Example display screens of the mobile electronic device are then described that may be employed in the illustrated environment, as well as in other environments without departing from the spirit and scope thereof.

### Example Environment

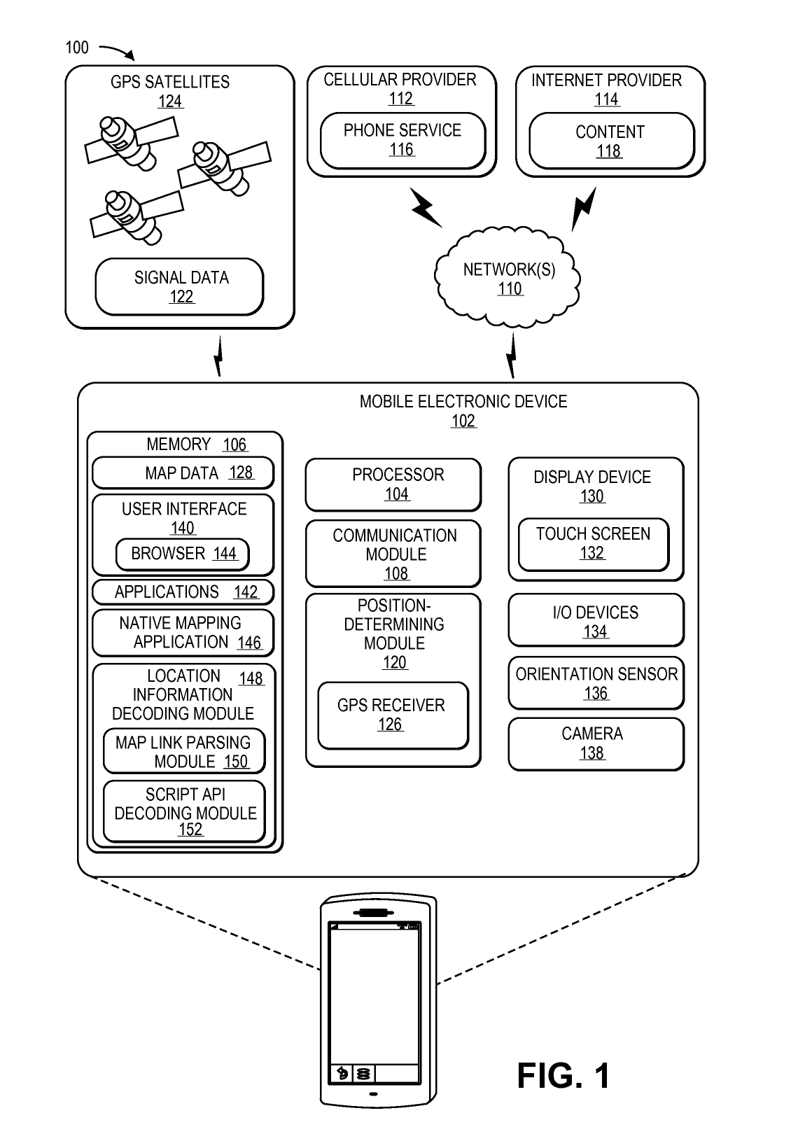

FIG. 1 illustrates an example mobile electronic device environment 100 that is operable to perform the techniques discussed herein. The environment 100 includes a mobile electronic device 102 operable to implement a user interface that controls the display of information and that allows a user to interact with the device 102. The mobile electronic device 102 may be configured in a variety of ways. For instance, a mobile electronic device 102 may be configured as a mobile phone, a smart phone, a position-determining device, a hand-held portable computer, a personal digital assistant, a multimedia device, a game device, combinations thereof, and so forth. In the following description, a referenced component, such as mobile electronic device 102, may refer to one or more entities, and therefore by convention reference may be made to a single entity (e.g., the mobile electronic device 102) or multiple entities (e.g., the mobile electronic devices 102, the plurality of mobile electronic devices 102, and so on) using the same reference number.

In FIG. 1, the mobile electronic device 102 is illustrated as including a processor 104 and a memory 106. The processor 104 provides processing functionality for the mobile electronic device 102 and may include any number of processors, micro-controllers, or other processing systems and resident or external memory for storing data and other information accessed or generated by the mobile electronic device 102. The processor 104 may execute one or more software programs which implement the techniques and modules described herein. The processor 104 is not limited by the materials from which it is formed or the processing mechanisms employed therein, and as such, may be implemented via semiconductor(s) and/or transistors (e.g., electronic integrated circuits (ICs)), and so forth.

The memory 106 is an example of device-readable storage media that provides storage functionality to store various data associated with the operation of the mobile electronic device 102, such as the software program and code segments mentioned above, or other data to instruct the processor 104 and other elements of the mobile electronic device 102 to perform the techniques described herein. Although a single memory 106 is shown, a wide variety of types and combinations of memory may be employed. The memory 106 may be integral with the processor 104, stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth. In embodiments of the mobile electronic device 102, the memory 106 may include removable ICC (Integrated Circuit Card) memory such as provided by SIM (Subscriber Identity Module) cards, USIM (Universal Subscriber Identity Module) cards, UICC (Universal Integrated Circuit Cards), and so on.

Mobile electronic device 102 also includes a communication module 108 representative of communication functionality to permit mobile electronic device 102 to send/receive data between different devices (e.g., components/peripherals) and/or over the one or more networks 110. Communication module 108 may be representative of a variety of communication components and functionality including, but not limited to: one or more antennas; a browser; a transmitter and/or receiver; a wireless radio; data ports; software interfaces and drivers; networking interfaces; data processing components; and so forth.

The one or more networks 110 are representative of a variety of different communication pathways and network connections which may be employed, individually or in combinations, to communicate among the components of the environment 100. Thus, the one or more networks 110 may be representative of communication pathways achieved using a single network or multiple networks. Further, the one or more networks 110 are representative of a variety of different types of networks and connections that are contemplated including, but not limited to: the Internet; an intranet; a satellite network; a cellular network; a mobile data network; wired and/or wireless connections; and so forth.

Examples of wireless networks include, but are not limited to: networks configured for communications according to: one or more standard of the Institute of Electrical and Electronics Engineers (IEEE), such as 802.11 or 802.16 (Wi-Max) standards; Wi-Fi standards promulgated by the Wi-Fi Alliance; Bluetooth standards promulgated by the Bluetooth Special Interest Group; and so on. Wired communications are also contemplated such as through universal serial bus (USB), Ethernet, serial connections, and so forth.

The mobile electronic device 102 through functionality represented by the communication module 108 may be configured to communicate via one or more networks 110 with a cellular provider 112 and an Internet provider 114 to receive mobile phone service 116 and various content 118, respectively. Content 118 may represent a variety of different content, examples of which include, but are not limited to: web pages; services; music; photographs; video; email service; instant messaging; and so forth.

In an implementation, the mobile electronic device 102 may include functionality to determine position. More particularly, mobile electronic device 102 may include a position-determining module 120 that may manage and process signal data 122 received from Global Positioning System (GPS) satellites 124 via a GPS receiver 126. For example, mobile electronic device 102 may receive signal data 122 transmitted by one or more position data platforms and/or position data transmitters, examples of which are depicted as the GPS satellites 124. The position-determining module 120 is representative of functionality operable to determine a geographic position through processing of the received signal data 122. The signal data 122 may include various data suitable for use in position determination, such as timing signals, ranging signals, ephemerides, almanacs, and so forth.

Position-determining module 120 may also be configured to provide a variety of other position-determining functionality. Position-determining functionality, for purposes of discussion herein, may relate to a variety of different navigation techniques and other techniques that may be supported by “knowing” one or more positions. For instance, position-determining functionality may be employed to provide location information, timing information, speed information, and a variety of other navigation-related data. Accordingly, the position-determining module 120 may be configured in a variety of ways to perform a wide variety of functions. For example, the position-determining module 120 may be configured for outdoor navigation, vehicle navigation, aerial navigation (e.g., for airplanes, helicopters), marine navigation, personal use (e.g., as a part of fitness-related equipment), and so forth. Accordingly, the position-determining module 120 may include a variety of devices to determine position using one or more of the techniques previously described.

The position-determining module 120, for instance, may use signal data 122 received via the GPS receiver 126 in combination with map data 128 that is stored in the memory 106 to generate navigation instructions (e.g., turn-by-turn instructions to an input destination or POI), show a current position on a map, and so on. Position-determining module 120 may include one or more antennas to receive signal data 122 as well as to perform other communications, such as communication via the one or more networks 110. The position-determining module 120 may also provide other position-determining functionality, such as to determine an average speed, calculate an arrival time, and so on.

Although a GPS system is described and illustrated in relation to FIG. 1, it should be apparent that a wide variety of other positioning systems may also be employed, such as other global navigation satellite systems (GNSS), terrestrial based systems (e.g., wireless-phone based systems that broadcast position data from cellular towers), wireless networks that transmit positioning signals, and so on. For example, positioning-determining functionality may be implemented through use of a server in a server-based architecture, from a ground-based infrastructure, through one or more sensors (e.g., gyros, odometers, and magnetometers), use of “dead reckoning” techniques, and so on.

The mobile electronic device 102 includes a display device 130 to display information to a user of the mobile electronic device 102. In embodiments, the display device 130 may comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. The display device 130 may be backlit via a backlight such that it may be viewed in the dark or other low-light environments.

The display device 130 may be provided with a touch screen 132 for entry of data and commands. For example, a user may operate the mobile electronic device 102 by touching the touch screen 132 and/or by performing gestures on the screen 132. In some embodiments, the touch screen 132 may be a capacitive touch screen, a resistive touch screen, an infrared touch screen, combinations thereof, and the like. The mobile electronic device 102 may further include one or more input/output (I/O) devices 134 (e.g., a keypad, buttons, a wireless input device, a thumbwheel input device, a trackstick input device, and so on). The I/O devices 134 may include one or more audio I/O devices, such as a microphone, speakers, and so on.

The mobile electronic device 102 may further include an orientation sensor 136 that represents functionality to determine various manual manipulation of the device 102. Orientation sensor 136 may be configured in a variety of ways to provide signals to enable detection of different manual manipulation of the mobile electronic device 102 including detecting orientation, motion, speed, impact, and so forth. For example, orientation sensor 136 may be representative of various components used alone or in combination, such as an accelerometer, gyroscope, velocimeter, capacitive or resistive touch sensor, and so on.

The mobile electronic device 102 of FIG. 1 may be provided with an integrated camera 138 that is configured to capture media such as still photographs and/or video by digitally recording images using an electronic image sensor. Media captured by the camera 138 may be stored as digital image files in memory 106. In embodiments, the digital image files may be stored using a variety of file formats. For example, digital photographs may be stored using a Joint Photography Experts Group standard (JPEG) file format. Other digital image file formats include Tagged Image File Format (TIFF), Raw data formats, and so on. Digital video may be stored using a Motion Picture Experts Group (MPEG) file format, an Audio Video Interleave (AVI) file format, a Digital Video (DV) file format, a Windows Media Video (WMV) format, and so forth. Exchangeable image file format (Exif) data may be included with digital image files to provide metadata about the image media. For example, Exif data may include the date and time the image media was captured, the location where the media was captured, and the like. Digital image media may be displayed by display device 130 and/or transmitted to other devices via a network 110 (e.g., via an email or MMS text message).

The mobile electronic device 102 is illustrated as including a user interface 140, which is storable in memory 106 and executable by the processor 104. The user interface 140 is representative of functionality to control the display of information and data to the user of the mobile electronic device 102 via the display device 130. The user interface 140 may provide functionality to allow the user to interact with one or more applications 142 of the mobile electronic device 102 by providing inputs via the touch screen 132 and/or the I/O devices 134. For example, the user interface 140 may cause an application programming interface (API) to be generated to expose functionality to an application 142 to configure the application for display by the display device 130. In embodiments, the API may further expose functionality to configure the application to allow the user to interact with an application 142 by providing inputs via the touch screen 132 and/or the I/O devices 134.

Applications 142 may comprise software, which is storable in memory 106 and executable by the processor 104, to perform a specific operation or group of operations to furnish functionality to the mobile electronic device 102. Example applications 142 may include cellular telephone applications, instant messaging applications, email applications, photograph sharing applications, calendar applications, address book applications, and so forth.

In implementations, the user interface 140 may include a browser 144. The browser enables the mobile electronic device 102 to display and interact with content 118 such as a webpage within the World Wide Web, a webpage provided by a web server in a private network, and so forth. The browser 144 may be configured in a variety of ways. For example, the browser 144 may be configured as an application 142 accessed by via the user interface 140. The browser 144 may be a web browser suitable for use by a full resource device with substantial memory and processor resources (e.g., a smart phone, a personal digital assistant (PDA), etc.). However, in one or more implementations, the browser may be a mobile browser suitable for use by a low-resource device with limited memory and/or processing resources (e.g., a mobile telephone). Such mobile browsers typically conserve memory and processor resources, but may offer fewer browser functions than web browsers.

The mobile electronic device 102 is further illustrated as including a native mapping application 146, which is storable in memory 106 and executable by the processor 104. The native mapping application 146 represents functionality to access map data 128 that is stored in the memory 106 to provide mapping and navigation functionality to the user of the mobile electronic device 102. For example, the native mapping application 146 may generate maps and/or map-related content for display by display device 130. As used herein, map related content includes information associated with maps generated by the native mapping application 146 and may include POIs, information associated with POIs, map legends, controls for manipulation of a map (e.g., scroll, pan, etc.), street views, aerial/satellite views, and the like, displayed on or as a supplement to one or more maps. The native mapping application 146 may utilize position data determined by the position-determining module 120 to show a current position of the user (e.g., the mobile electronic device 102) on a displayed map, furnish navigation instructions (e.g., turn-by-turn instructions to an input destination or POI), calculate driving distances and times, and so on.

In one or more implementations, the native mapping application 146 is configured to utilize the map data 128 to generate maps and/or map-related content for display by the mobile electronic device 102 independently of content sources external to the mobile electronic device 102. Thus, for example, the native mapping application 146 may be capable of providing mapping and navigation functionality when access to external content 118 is not available through network 110. It is contemplated, however, that the native mapping application 146 may also be capable of accessing a variety of content 118 via the network 110, such as content from a web mapping service, to generate maps and/or map-related content for display by the mobile electronic device 102.

In accordance with the techniques described herein, the mobile electronic device 102 is illustrated as including a location information decoding module 148 which is storable in memory 106 and executable by the processor 104. The location information decoding module 148 is representative of functionality to identify and decode location information within content accessed by the mobile electronic device 102, such as content 118 accessed via a network 110, content stored in memory 106, and so on. In embodiments, location information may be decoded from a variety of different types of content, examples of which include, but are not limited to: web pages; documents; services; photographs; email; instant messaging messages; and so forth.

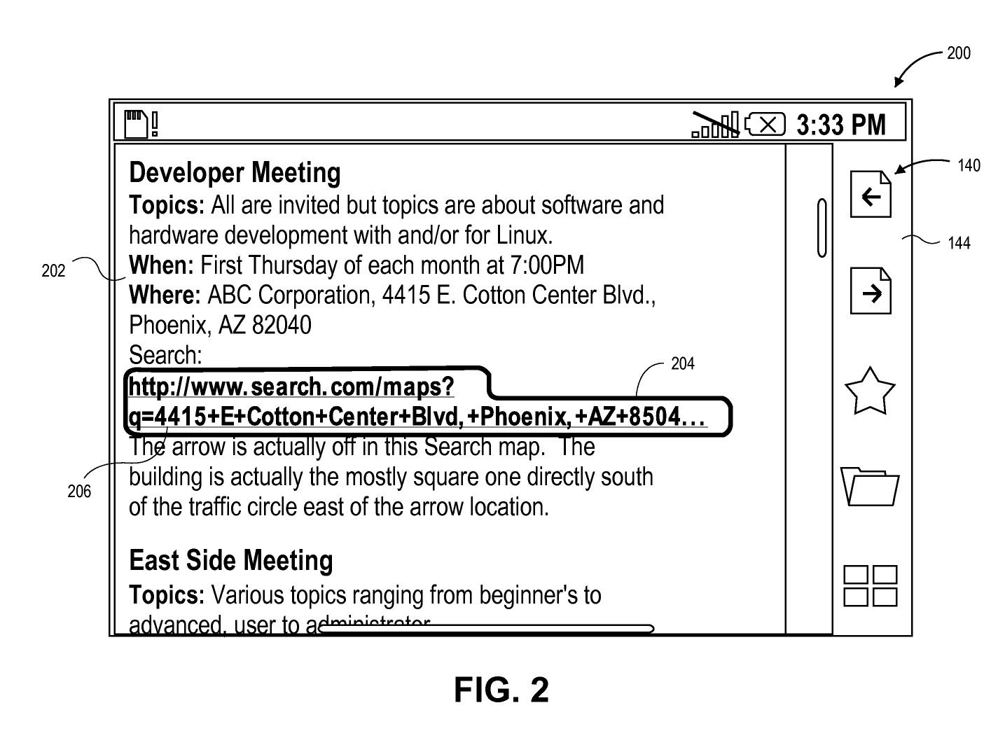

In implementations, the location information is decoded from a map link embedded in the content 118 or from location information parameters associated with a mapping API call made by a mapping script embedded in the content 118. FIGS. 2, 3, and 4 illustrate display screens 200, 300, 400 of the mobile electronic device 102 of FIG. 1 in which content 202 is displayed. In FIG. 2, the user interface 140 is configured to display content 202 that includes a map link 204 that may be followed by the browser 144 to access a webpage of a website operated by a web mapping service. Without limitation, web mapping services may include any service that provides maps and/or map related content that may be accessed by the mobile electronic device 102. Example web mapping services include, but are not limited to: the Google Maps mapping service, the MapQuest mapping service, the Yahoo Maps mapping service, the Bing Maps mapping service and the Openstreetmaps mapping service.

As shown, the map link 204 may include embedded location information 206 that is used by the web mapping service to access maps and/or map-related content provided by the service via the service's website. The location information 206 may be formatted in a variety of ways. For instance, in the illustrated embodiment, the location information 206 is formatted as a search string containing components of an address (e.g., “q=4415+E+Cotton+Center+Blvd,+Phoenix,+AZ+85040”). However, the location information 206 may also be formatted as map coordinates (e.g. latitude and longitude), an address, encoded information such as geocodes, POI categories, and so forth.

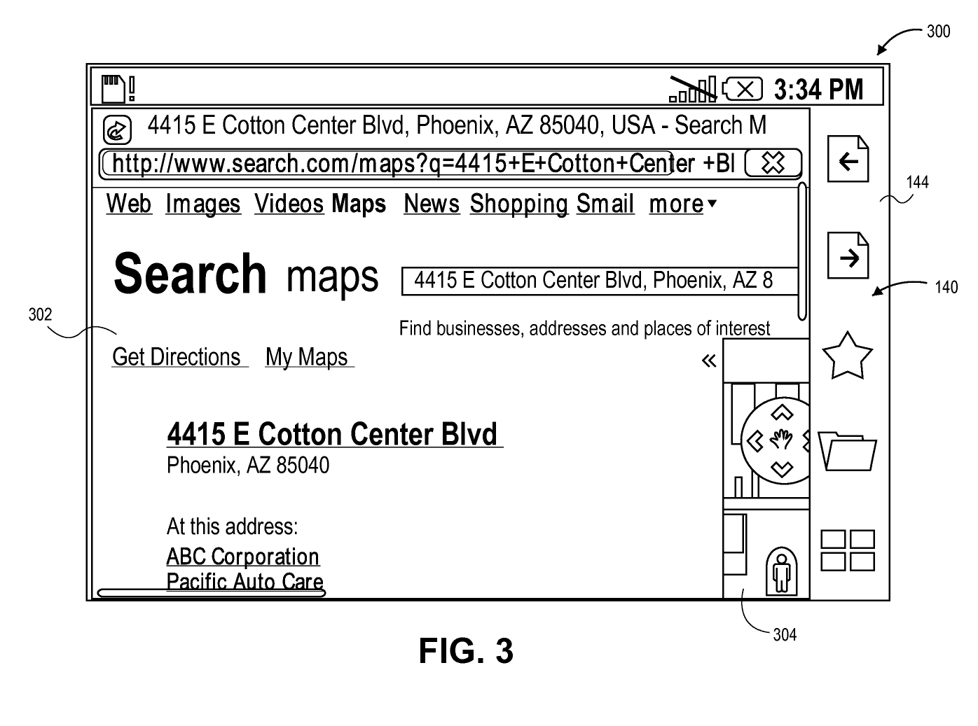

When selected, the map link 204 causes the browser 144 to access maps and/or map related content furnished by a web mapping service via its website. For example, in the illustrated embodiment, selection of the map link 204 may cause the browser 144 to access one or more pages of the web mapping service's website to display a map of the address (e.g., “4415 E. Cotton Center Blvd., Phoenix, Ariz. 85040”) specified by the location information 206 contained in the map link 204. FIG. 3 illustrates the mapping webpage 302 accessed via the map link 204. As shown, the mapping webpage 302 may not be formatted for display by the display device 130. Thus, features of the mapping webpage 302, such as map 304 of selected location may not be immediately viewable by the user of the mobile electronic device 102, forcing the user to zoom or scroll the webpage 302 to view desired information on the map 304—a tedious and cumbersome task.

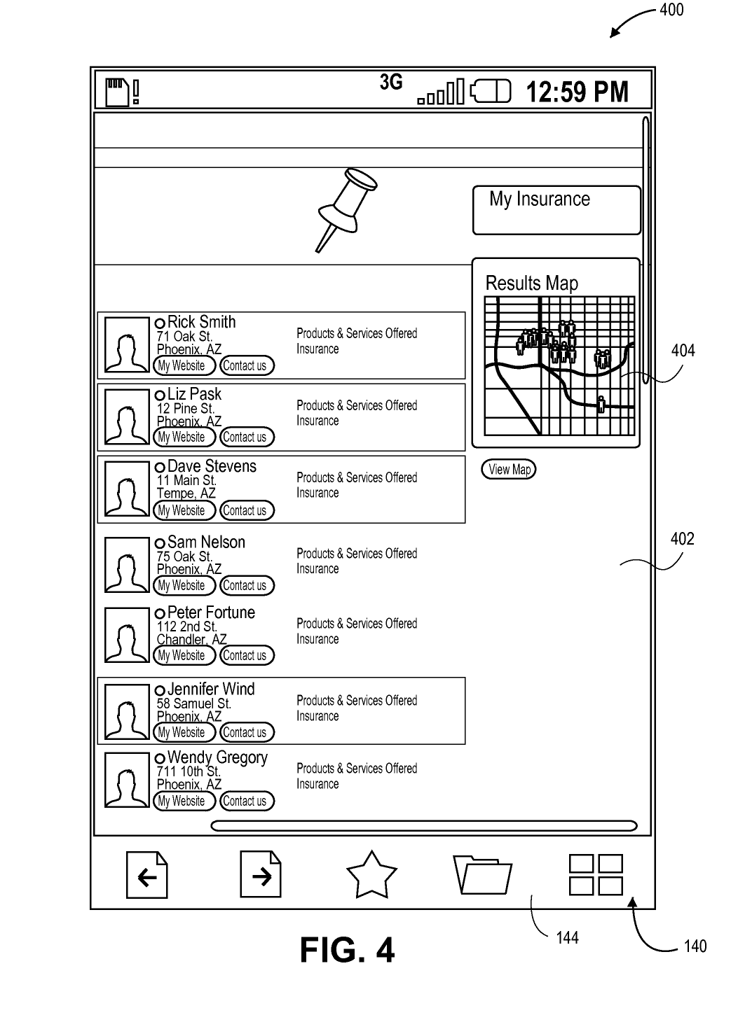

FIG. 4 illustrates a webpage 402 of a third party website that contains a map 404 furnished by a web mapping service. The map 404 is generated by an embedded script that calls a mapping API from the web mapping service website when the webpage is accessed by the browser 144. In one or more embodiments, the mapping API may comprise a Google Maps API, a MapQuest API, a Bing Maps API, and so on, called by mapping JavaScript embedded within the webpage 402.

As shown in FIG. 4, the webpage 402 may not be formatted for display by the display device 130. Thus, the embedded map 404 may be not be immediately viewed by the user, lessening the user experience. For example, the embedded map may be too small to be easily read or may not initially be contained within the viewing area of the display device 130.

Accordingly, in FIG. 1, the location information decoding module 148 is illustrated as including a map link parsing module 150 and/or a script API decoding module 152. The map link parsing module 150 represents functionality to identify map links within content 118 accessed by the mobile electronic device 102 and parse the identified map links to obtain location information. Similarly, the script API decoding module 152 of FIG. 1 represents functionality to decode location information from location information parameters associated with a mapping API call made by a mapping script embedded in the content 118. In one or more embodiments, the mapping script may be configured to call a native mapping application programming interface (API) that is configured to automatically access the native mapping application 146 when called by the mapping script. In one or more embodiments, the native mapping API may be a Garmin® JavaScript Map API. However, other examples are possible.

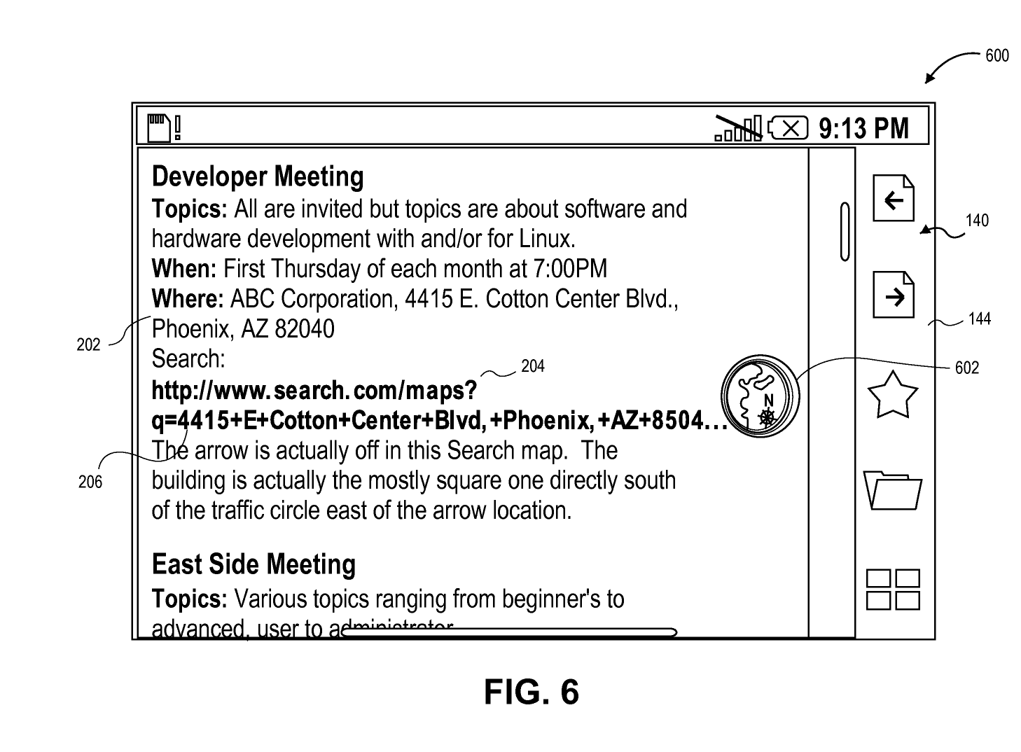

The location information decoding module 148 may then pass the decoded location information to the native mapping application 146. Map-related functions can then be provided by the mobile electronic device 102 by accessing functionality of the native mapping application 146 using the decoded location information. For example, in one or more embodiments, the location information decoding module 148 may cause the user interface 140 to display indicia such as an icon or menu (see FIGS. 6 through 10) configured to access functionality of the native mapping application 146.

Functionality provided by the native mapping application 146 may be employed in place of, or in combination with, functionality provided by the web mapping service. For example, the native mapping application 146 may generate maps from map data 128 stored in memory 106 of the mobile electronic device 102 to be displayed in place of corresponding maps provided by the web mapping service. These maps can include a variety of map-related content (e.g., one or more POIs, a satellite view of the mapped area, an aerial view of a location on the map, etc.) retrieved from external sources such as the web mapping service.

Generally, any of the functions described herein can be implemented using software, firmware, hardware (e.g., fixed logic circuitry), manual processing, or a combination of these implementations. The terms “module” and “functionality” as used herein generally represent software, firmware, hardware, or a combination thereof. In the case of a software implementation, for instance, the module represents executable instructions that perform specified tasks when executed on a processor, such as the processor 104 with the mobile electronic device 102 of FIG. 1. The program code can be stored in one or more device-readable storage media, an example of which is the memory 106 associated with the mobile electronic device 102 of FIG. 1.

### Example Procedures

The following discussion describes procedures that may be implemented in a mobile electronic device. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference may be made to the environment 100 of FIG. 1 and the display screens 200, 300, 400 of FIGS. 2, 3, and 4, respectively. The features of techniques described below are platform-independent, meaning that the techniques may be implemented on a variety of commercial mobile electronic device platforms having a variety of processors.

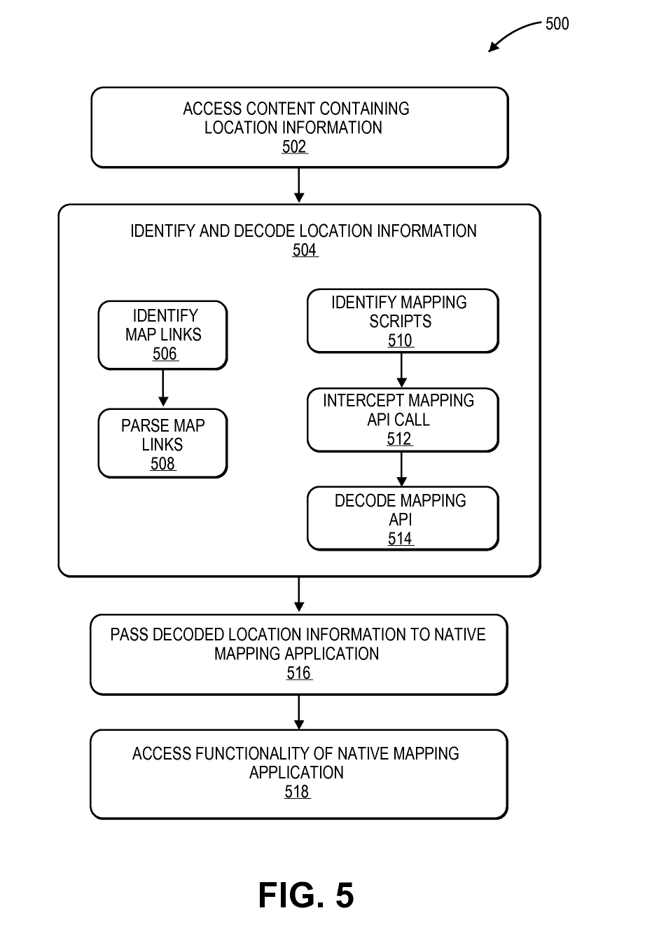

FIG. 5 depicts a procedure 500 in an example implementation in which location information in content accessed by a mobile electronic device is decoded and passed to a native mapping application resident on the device. As shown, the mobile electronic device may access content containing location information (Block 502). Without limitation, content that may be accessed by the mobile electronic device 102 includes webpages, documents, files, multimedia files, emails, instant messages (IMs), addresses, and so on. Such content may include content 118 furnished to the mobile electronic device from an external source via a network 110 using the browser 144. Accessed content may also include content such as documents, address book entries, calendar entries, emails or instant messages, webpages, and so on, stored in memory 106.

Location information within the content is then identified and decoded (Block 504). For example, as discussed with respect to FIG. 2, content 202 accessed by the mobile electronic device 102 may include one or more map links 204 that include embedded location information 206. The map links 204 may be identified or recognized (Block 506). Map links 204 may be identified automatically using any suitable processing technique. As such, in at least some implementations, no user participation is necessary to perform this operation. Without limitation, suitable processing techniques may include employing filtering, parsing, searching, sorting, hashing, use of statistical models and/or imperative functions implemented in software, hardware, firmware or any combination thereof.

Once identified, the map links are parsed (Block 508) to obtain location information. For example, in FIG. 2, a map link 204 is illustrated that includes location information 206 formatted as a search string containing components of an address (e.g., “q=4415+E+Cotton+Center+Blvd,+Phoenix,+AZ+85040 . . . ”). Parsing of the map link 204 may include map matching and data conversion techniques to convert location information identified within the map link 204 to a suitable format for use by the mobile electronic device 102. For instance, a latitude, longitude, and/or other geocode found within a map link may be map matched to produce a location name, street address, or other location data suitable for routing purposes. In some configurations, conversion of identified location data to other formats is not necessary.

The map link 204 illustrated in FIG. 2 may be parsed to extract the address (e.g., “4415 E Cotton Center Blvd., Phoenix, Ariz. 85040”). Other example map links and extracted addresses include:

(1) http://www.mapquest.com/maps?state=AZ&address=1050+W+Ray+Rd&zipcode=85224&country=US&latitude=33.32067&longitude=−111.859675

### Extracted to:

### 1050 W Ray Rd

### AZ, 85224

(33.32067, −111.859675)
(2) http://maps.google.com/maps?hl=en&ie=UTF8&q=chinese+art+academy+chandl er+az&11=33.336893,-111.876376&fb=1&split=1&g1=us&cid=0,0,17152106759966317405&ei=wMiWSp36K 46QNpibyIkD&spn=0.010111,0.022724&iwloc=A

### Extracted to:

### Chinese Art Academy Chandler

(33.336893, −111.87637)
(3) http://www.mapquest.com/maps?name=China+King+Buffet&address=1050+W+Ray+Rd&zipcode=85224

### Extracted to:

### China King Buffet

### 1050 W Ray Rd

85224

As discussed with respect to FIG. 4, the content accessed by the mobile electronic device 102 may also include mapping scripts that are configured to call a mapping API from a web mapping service website to generate an embedded map. For example, a webpage document may include JavaScript that calls a Google Map API from the Google Maps website to cause a map to be embedded within the webpage. Examples of intercepted objects from Google Maps API may include: * GMap2.setCenter( ), setZoom( ), addOverlay( ) and * GMarker.openInfoWidowHtml( ).

As shown, the mapping scripts within the content are first identified (Block 510). The mapping scripts may be identified automatically using any suitable processing technique. Thus, in at least some implementations, no user participation is necessary to perform this operation. Without limitation, suitable processing techniques may include employing filtering, parsing, searching, sorting, hashing, use of statistical models and/or imperative functions implemented in software, hardware, firmware or any combination thereof.

Mapping API calls made by the mapping script may then be intercepted (Block 512) and decoded (Block 514) to extract location information from location information parameters associated with the mapping API. For example, in FIG. 4, mapping JavaScript may be identified within the content 202, allowing the mapping API call to be intercepted. Location information may then be decoded from the location information parameters associated with the mapping API.

The decoded location information may then be passed to the native mapping application (Block 516). For example, the user interface 140 may be configured to allow the user to input a selection (e.g., via an icon or menu) to access functionality of the native mapping application 146 using the decoded location information or to access content (e.g., a mapping webpage) furnished by the web mapping service without use of the native mapping application 146. In one or more embodiments, the decoded location information is passed to the native mapping application 146 after input of this selection is received from the user. However, it is contemplated that, in other embodiments, the decoded location information may be automatically passed to the native mapping application without user intervention. Various Android-related interfaces are illustrated in the figures, but embodiments of the present invention may be employed using any operating systems, software applications, mobile environments, and the like.

Decoded location information may be passed to the native mapping application in a variety of formats. In one or more embodiments, the location information may be geo-coded. However, it is contemplated that the decoded location information may be passed to the native mapping application as an address (e.g., “4415 E Cotton Center Blvd., Phoenix, Ariz. 85040”).

Geo-coding may be accomplished by assigning one or more geographical identifiers or coordinates, such as a latitude and longitude for example, to data. More particularly, with respect to the location information, address information may be converted into one or more geographical identifiers or coordinates. This allows the location information to be provided (e.g., displayed or otherwise made available) in the context of, and with respect to, available map data. For example, a particular coordinate, as expressed by a latitudinal value and longitudinal value, may be integrated with corresponding map data such that its location may be provided in the context surrounding geographical features (e.g., roads, mountains, water features, businesses, residences etc.). Furthermore, additional information associated with the location and/or the surrounding features may also be provided such as, without limitation, current weather conditions, road construction/delays, business details (e.g., name, location, contact information, hours of operation and types of goods and/or services they provide) and/or residence details (e.g., name, location, contact information, etc.).

Geo-coding may be performed automatically using a variety of suitable geo-coding engines and/or processes. For instance, in at least some embodiments a geo-coding engine employing boolean logic (requiring exact matches) and/or fuzzy logic (allowing approximate matches) may be employed.

Functionality of the native mapping application may then be accessed using the decoded location information (Block 518). For instance, functionality of the native mapping application 146 may be accessed to combine the location information with other data stored locally, such as map data 128 in memory 106. Thus, for example, a native map (i.e., a map generated by the native mapping application using map data 128) may be displayed that includes indicia indicating the location of favorite locations stored by the user in memory 106 as map data 128 in combination with locations (e.g., hotel locations, restaurant locations, automobile service center locations, etc.) retrieved through an Internet search.

Functionality of the native mapping application 146 may also be accessed to provide a simplified user interface when interacting with displayed maps. The native mapping application 146 may, for example, cause a native map to be displayed instead of a map furnished by the web mapping service. This native map may be formatted specifically for display by the display device 130. The native mapping application 146 may further provide map viewing controls that are configured to allow easy manipulation of the map, for example, using the touch screen 132.

The native mapping application 146 may furnish access to functionality provided by other applications 142 of the mobile electronic device 102. For example, the native mapping application 146 may be configured to interact with an instant messaging application, an email application, a telephone application, a browser, or the like, to forward the decoded location information to one or more other devices via instant messaging, email, phone message, and so on.

Still further, functionality of the native mapping application 146 may be used by a website to conserve the webpage's use of network bandwidth when loading content to the browser 144 of the mobile electronic device. In this manner, the performance of the website may be improved when accessed by mobile electronic devices 102, to enhance the user experience provided by the website to the mobile electronic device users.

### Example User Interface

The following discussion describes example display screens of a user interface that may be generated using the processes and techniques discussed herein. Aspects of the user interface may be generated in hardware, firmware, software or a combination thereof. In portions of the following discussion, reference will be made to the environment 100 of FIG. 1, the display screens 200, 300, 400 of FIGS. 2, 3, and 4, respectively, the procedure 500 of FIG. 5, and/or other example environments and procedures.

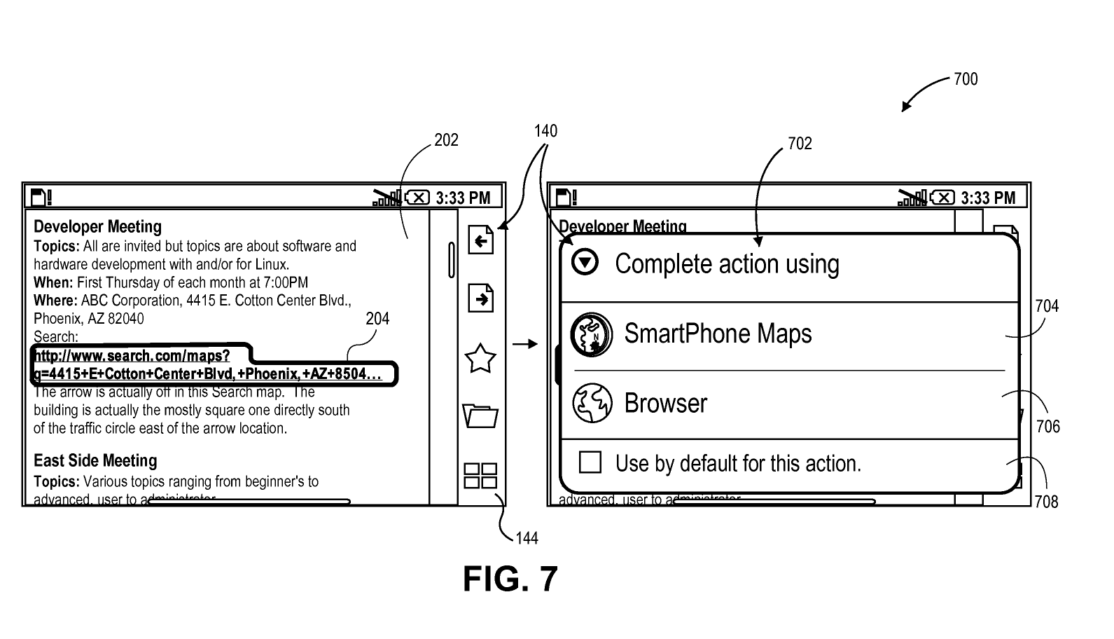

FIGS. 6 and 7 illustrate example display screens 600, 700 provided by the user interface 140 of the mobile electronic device 102 of FIG. 1 in which content 202 containing a map link 204 is accessed by the browser 144. In FIG. 6, the user interface 140 is configured to cause an icon 602 to be displayed within the content 202 adjacent to the map link 204. When selected by the user of the mobile electronic device 102, the icon 602 opens the native mapping application 146 and loads the decoded location information from the map link 204. Since the map link 204 remains intact, selection of the map link 204 instead of the icon 602 causes the browser 144 to navigate to the web mapping service website. Thus, in the illustrated example, selection of the map link 204 may cause the browser 144 to open a webpage within the web mapping service website to display a map of area surrounding the address (e.g., “4415 E. Cotton Center Blvd., Phoenix, Ariz. 85040”) specified by the location information 206 embedded within the map link 204. However, in other configurations, selection of the map link 204 may trigger access of the native mapping application 146 and loading of the decoded location information without requiring the user to directly select the icon 602.

In FIG. 7, the user interface 140 is configured to cause a menu 702 to be displayed in response to selection of the map link 204 to access functionality provided by the native mapping application 146. In one embodiment, the menu 702 is configured as a “popup” menu that is displayed over the content 202. However, it is contemplated that the menu 702 may have a variety of formats, which may or may not allow the content to be viewed while the menu 702 is present. As shown, the menu 702 may include a first selectable menu item (“SmartPhone Maps”) 704 configured to access the native mapping application 146 and a second selectable menu item (“Browser”) 706 configured to follow the map link 204 to open the target content (e.g., a mapping webpage provided by the web mapping service) specified by the map link 204 within the browser 144. Selection of the first selectable menu item opens the native mapping application 146 and loads the decoded location information from the map link 204. Conversely, selection of the second selectable menu item 706 causes the browser 144 to navigate to the web mapping service website. Thus, in the illustrated example, selection of the second selectable menu item 706 may cause the browser 144 open a webpage within the web mapping service website to display a map of area surrounding the address (e.g., “4415 E. Cotton Center Blvd., Phoenix, Ariz. 85040”) specified by the location information 206 embedded within the map link 204.

In one or more embodiments, the menu 702 may further include a third selectable menu item (“Use by default for this action.”) 708 that may be selected by the user to set one of the first selectable menu item 704 or the second selectable menu item 706 as a default selection. Thereafter, when a map link 204 contained in content 202 accessed by the mobile electronic device 102 is selected, the default selection, e.g., the native mapping application or the web mapping service via the browser 144, is opened. The menu 702 would thus no longer be displayed. However, it is contemplated that the user interface 140 may be configured to allow the user to manually access the menu 702 to change or cancel the default setting.

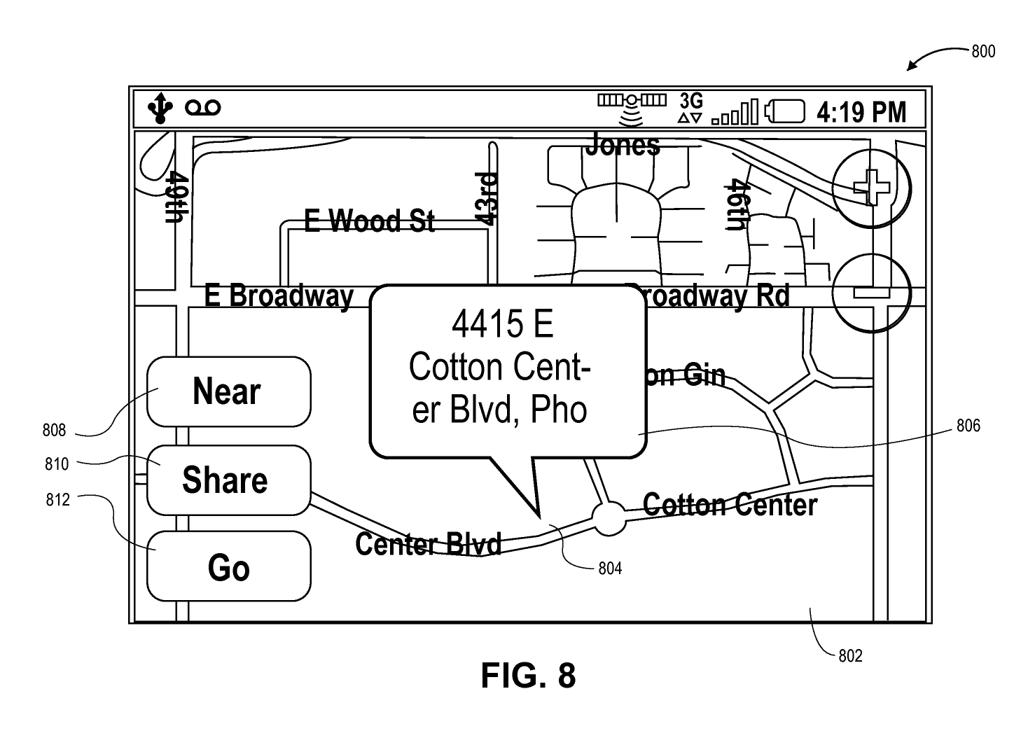

FIG. 8 illustrates an example map display screen 800 provided by the user interface 140 of the mobile electronic device 102 of FIG. 1. In FIG. 8, the user interface 140 is configured to cause a native map 802 generated by the native mapping application 146 to be displayed in response to selection of the icon 602 shown in FIG. 6 or the first selectable menu item 704 of the menu 702 shown in FIG. 7. The native map 802 is formatted to depict an area surrounding the location 804 contained in the map link 204. In the example shown, a text bubble 806 pinned to the map 802 identifies the location 804 on the map 802 (e.g., by address, map coordinates, name, etc.).

From the map display screen 800, the user may access functionality provided by the native mapping application 146. For example, the user may access functionality of the native mapping application 146 by selecting one or more mapping function controls 808, 810, 812 displayed over the map 802. Thus, as shown in FIG. 8, the user may invoke functionality to search for POIs near the location 804 by selecting the mapping function control “Near” 808, whereupon the native mapping application 146 may initiate a search of map data 128 stored in memory 106 for POIs near the location 804. Similarly, the user may invoke functionality to share the location 804 with users of other mobile electronic devices 102 such as friends in a social network by selecting the mapping function control “Share” 810, whereupon the native mapping application may access functionality provided by the communication module 108 to insert location information an email, instant message, text message, blog post, or the like. Additionally, the user may access turn-by-turn navigation functionality by selecting the mapping function control “Go” 812, whereupon the native mapping application 146 may provide turn-by turn navigation instructions to reach the location 804.

Information stored within a local database (e.g., a database stored within memory 106) may also be accessed. For example, map display screen 800 may be configured to display information such as favorite locations, locations of friends of the user, and so forth. These locations may be displayed by icons (e.g., flags, push pins, etc.) on the map 802 to illustrate their proximity to the location 804 identified from the decoded location information.

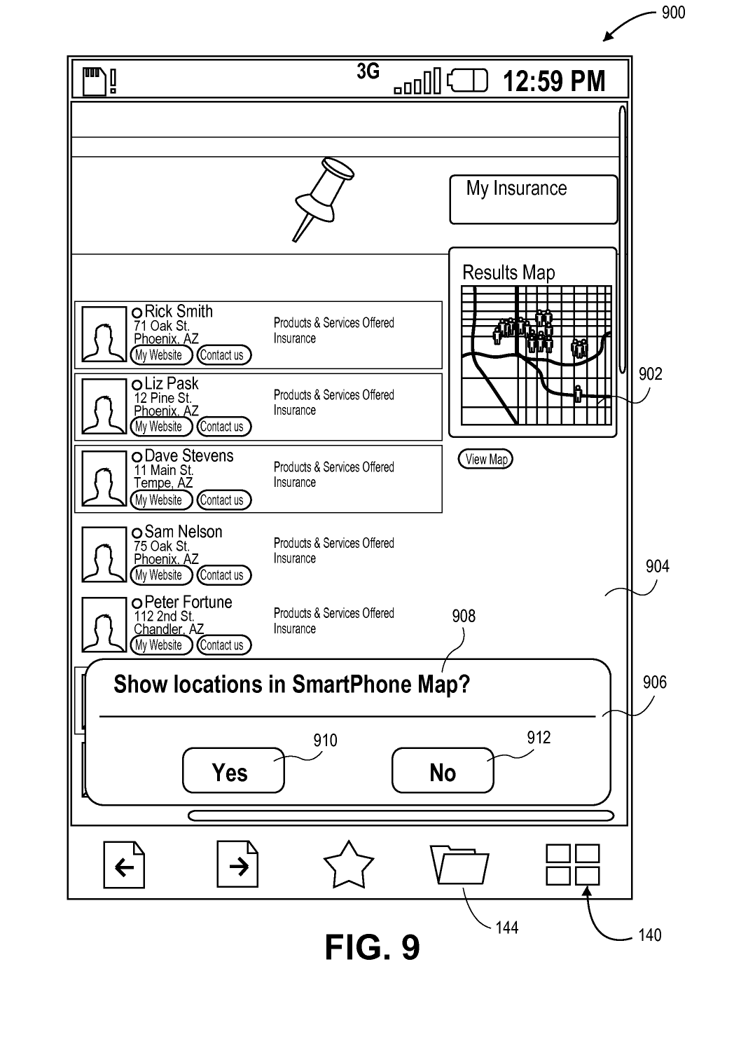

FIG. 9 illustrates an example display screens 900 provided by the user interface 140 of the mobile electronic device 102 of FIG. 1 in which content 202 containing an embedded map 902 is accessed by the browser 144. As discussed above, the map 902 may be generated by embedded mapping scripts that are configured to call a mapping API from a web mapping service. For example, in FIG. 9, the content access is a webpage 904 that includes JavaScript, embedded within the webpage 904, which calls a Google Map API from the Google Maps website to generate the map 902. In FIG. 9, the user interface 140 is configured to cause a menu 906 to be displayed, in response to interception of the mapping API call, to access functionality provided by the native mapping application 146. In one or more embodiments, the menu 906 may be configured as a “popup” menu that is displayed over the content 202. However, it is contemplated that the menu 906 may have a variety of formats, which may or may not allow the content to be viewed while the menu 906 is present.

As shown, the menu 906 provides a prompt (“Show locations in SmartPhone Map?”) 908 to the user. To receive input in response to the prompt 908, the menu 906 includes a first selectable menu item (“Yes”) 910 that may be selected by the user to access functionality of the native mapping application 146 generate a native map for display in place of the map 902, and a second selectable menu item (“No”) 912 that may be selected by the user to display the map 902 retrieved from a web mapping service.

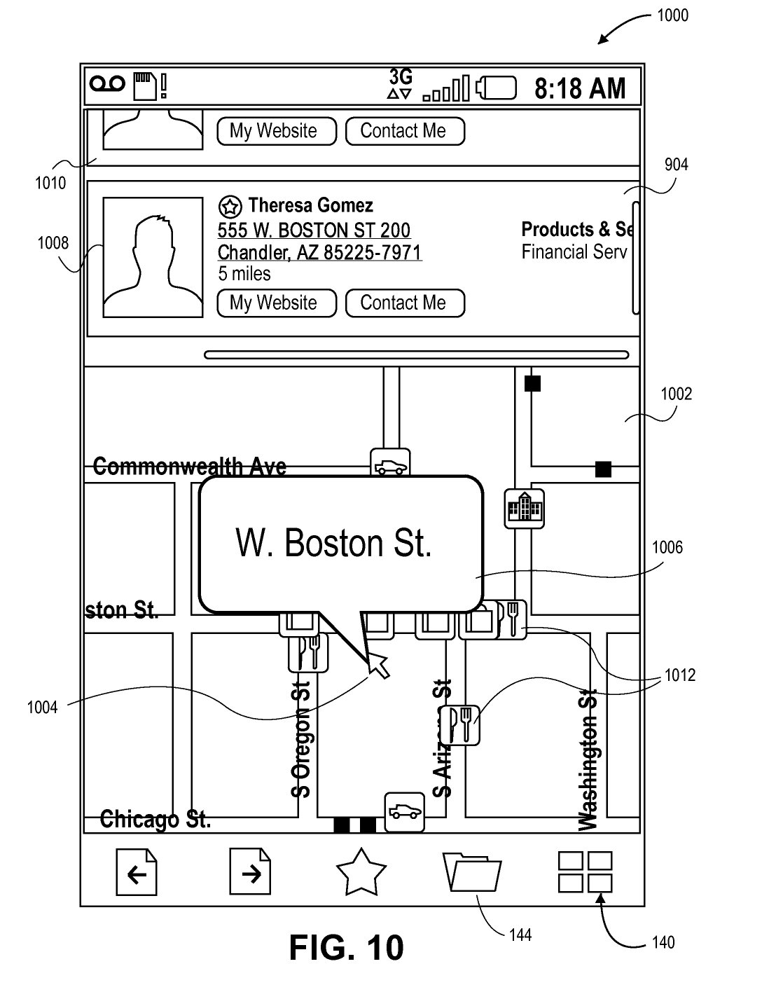

FIG. 10 illustrates an example map display screen 1000 provided by the user interface 140 of the mobile electronic device 102 of FIG. 1. In FIG. 10, the user interface 140 is configured to cause a native map 1002 generated by the native mapping application 146 to be embedded within the webpage 904 in response to selection of the first selectable menu item 910 of the menu 906 shown in FIG. 9. The native map 1002, which may replace the map 902 retrieved from the web mapping service (FIG. 9), is formatted to depict an area surrounding a location 1004 identified by location information decoded from mapping API. As in FIG. 8, a text bubble 1006 pinned to the native map 1002 may identify the location 1004 on the map 1002 (e.g., by address, map coordinates, name, etc.).

In one or more embodiments, the user interface 140 may continue to display content 1008 of the webpage 904 accessed by the browser 144 adjacent to the native map 1002. However, this content 1008 may be reformatted for display with the native map 1002, which may occupy a larger portion of display than did the map 902 retrieved from the web mapping service.

The user interface 140 may provide for two way interaction between the native map 1002 and content 1008 of the webpage 904. For example, the content 1008 furnished by the webpage 904 may include one or more content elements 1010 that are associated with location information (e.g., the content elements 1010 may contain embedded mapping scripts configured to call mapping APIs containing location information). Content elements 1010 may comprise any element within a webpage 904 that is associated with location information. For example, content elements 1010 may include biographical listings, address listings, contact information, photographs, text, graphics, and so on.

The user may manipulate (e.g., scroll through) the content 1008 to select one or more content elements 1010. When a content element 1010 is selected, the user interface 140 may cause the native map 1002 to automatically re-center on the location identified associated with the selected content item 2010. Similarly, as the user manipulates (e.g., scrolls or pans) the native map 1002, user interface 140 may cause the content 1008 to be manipulated in a corresponding manner. For example, a user may pan the native map 1002 to cause the content 1008 to auto-focus on the content elements 1010 associated with locations near the center of the native map 1002. Other interactions between the native map 1002 and content 1008 of the webpage 904 are contemplated. For example, information contained within a content element 1010 (e.g., a photograph, a business name, etc.) may be extracted from the content element 1010 for display on the native map 1002, sections of the native map 1002 (e.g., an intersection) may be embedded within a contact element 1010. Thus, interaction between the native map 1002 and content 1008 of the webpage 904 should not be limited to the specific examples described herein.

Information stored within a local database (e.g. a database stored within memory 106) may also be accessed. Thus, map display screen 1000 may be used to display a variety of information in addition to the native map 1002. Without limitation, the map display screen 1000 may be configured to display favorite locations, locations of friends of the user in a social network, and so forth. These locations may be displayed by icons (e.g., flags, push pins, etc.) 1012 on the native map 1002 to illustrate the proximity of the locations to the location 804 obtained from the decoded location information.

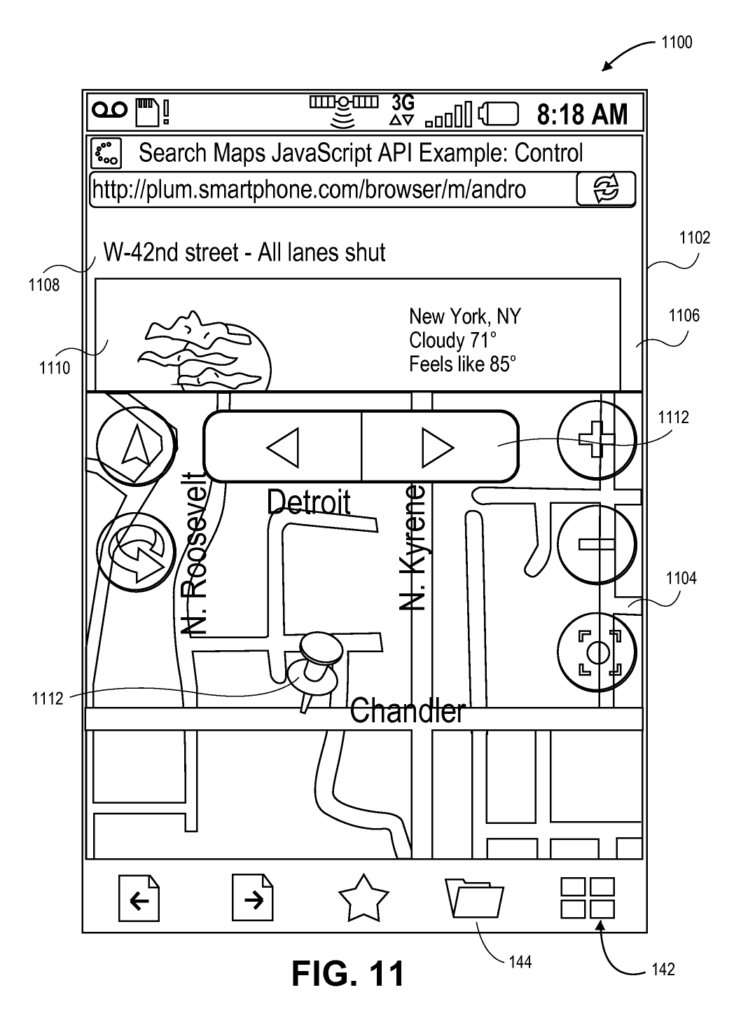

As discussed herein, a predefined native mapping API may be configured to automatically invoke functionality provided by the native mapping application 146 when called by a mapping script embedded in content accessed by the mobile electronic device 102. FIG. 11 illustrates an example display screen 1100 provided by the user interface 140 of the mobile electronic device 102 of FIG. 1. In FIG. 11, the user interface 140 is configured to display a webpage 1102 of a web site accessed via the browser 144. The website employs predefined native mapping APIs to access the native mapping application 146 to embed a native map 1104 within the webpage 1102. The website may furnish content 1106 (e.g., traffic and weather information 1108, 1110) which is displayed with the native map 1104. In embodiments, the webpage 1102 may further include mapping scripts (e.g., JavaScript) configured to control the contents of the embedded map 1104. For example, the webpage 1102 may cause the native map 1104 to display a location, such a location associated with the website owner, as a POI 1112 within the native map 1104. Controls 1114 may be embedded with the map 1104 to allow manipulation of the map 1104 by the user

Functionality of the native mapping application 146 may thus be used by the website to conserve the use of network bandwidth when loading content 1106 of the webpage 1102 to the browser 144 of the mobile electronic device 102. In this manner, the performance of the website (e.g., speed of loading) is improved, enhancing the user experience.

### CONCLUSION

Although techniques to decode location information in content accessed by a mobile electronic device and pass the decoded information to a native mapping application have been described in language specific to structural features and/or methodological acts, it is to be understood that the appended claims are not necessarily limited to the specific features or acts described. Rather, the specific features and acts are disclosed as exemplary forms of implementing the claimed devices and techniques.

What is claimed is:

1. A mobile electronic device comprising:
a memory operable to store a module; and
a processing system operable to execute the module to:
decode location information from at least one of a map link embedded in content accessed from one or more sources or location information parameters associated with an application programming interface (API) call made by a mapping script embedded in the content;
pass the decoded location information to a native mapping application; and
cause a map-related function to be provided, the map-related function configured to access functionality of the local mapping application using the decoded location information.

2. The mobile electronic device as recited in claim 1, wherein the module is configured to identify the map link in the content and parse the map link to obtain the location information.

3. The mobile electronic device as recited in claim 2, further comprising a display configured to display the content, wherein the module is configured to cause an icon to be displayed within the content in proximity to the map link, the icon configured to access the native mapping application.

4. The mobile electronic device as recited in claim 1, further comprising a display configured to display the content, wherein the module is configured to cause a menu to be displayed by the display, the menu configured to access the native mapping application.

5. The mobile electronic device as recited in claim 4, wherein the menu comprises a first selectable menu item configured to access the native mapping application and a second selectable menu item configured to open the map link.

6. The mobile electronic device as recited in claim 5, wherein the menu further comprises a third selectable menu item configured to set one of the first selectable item or the second selectable item as a default selection.

7. The mobile electronic device as recited in claim 1, wherein the module is configured to identify the mapping script in the content and thereafter to intercept the application programming interface (API) call made by the mapping script.

8. A mobile electronic device comprising:
a memory operable to store a module; and
a processing system operable to execute the module to:
decode location information from a map link embedded in content accessed from one or more sources;
pass the decoded location information to a native mapping application; and
cause a map-related function to be provided, the map-related function configured to access functionality of the local mapping application using the decoded location information.

9. The mobile electronic device as recited in claim 8, wherein the module is configured to identify the map link in the content and parse the map link to obtain the location information.

10. The mobile electronic device as recited in claim 9, further comprising a display configured to display the content, wherein the module is configured to cause an icon to be displayed within the content in proximity to the map link, the icon configured to access the native mapping application.

11. The mobile electronic device as recited in claim 9, further comprising a display configured to display the content, wherein the module is configured to cause a menu to be displayed by the display, the menu configured to access the native mapping application.

12. The mobile electronic device as recited in claim 11, wherein the menu comprises a first selectable menu item configured to access the native mapping application and a second selectable menu item configured to open the map link.

13. The mobile electronic device as recited in claim 12, wherein the menu further comprises a third selectable menu item configured to set one of the first selectable item or the second selectable item as a default selection.

14. A method comprising:
decoding location information from at least one of a map link embedded in content accessed by a mobile electronic device or location information parameters associated with an application programming interface (API) call made by a mapping script embedded in the content;
passing the decoded location information to a native mapping application of the mobile electronic device; and
causing a map-related function to be provided by the mobile electronic device, the map-related function configured to access functionality of the native mapping application using the decoded location information.

15. The method as recited in claim 14, wherein the decoding of location information from a map link comprises detecting the map link in the content and parsing the map link to obtain the location information.

16. The method as recited in claim 15, wherein the passing of the decoded location information to the native mapping application further comprises injecting an icon into the content in proximity to the map link, the icon configured to access the native mapping application.

17. The method as recited in claim 14, wherein the passing of the decoded location information to the native mapping application further comprises causing a menu to be displayed, the menu configured to access the native mapping application.

18. The method as recited in claim 17, wherein the menu comprises a first selectable menu item configured to access the native mapping application and a second selectable menu item configured to open the map link.

19. The method as recited in claim 18, wherein the menu further comprises a third selectable menu item configured to set one of the first selectable item or the second selectable item as a default selection.

20. The method as recited in claim 14, wherein the decoding of location information from a mapping script comprises identifying the mapping script in the content and intercepting the application programming interface (API) call made by the mapping script.
